(19) United States
(12) Patent Application Publication
(10) Pub. No.: US 2023/0266456 A1
(43) Pub. Date: Aug. 24, 2023

(54) SYSTEMS AND METHODS OF TARGET DETECTION

(71) Applicant: ELTA SYSTEMS LTD., Ashdod (IL)

(72) Inventor: Jacob ROVINSKY, Modiin (IL)

(21) Appl. No.: 18/005,099

(22) PCT Filed: Jul. 7, 2021
(86) PCT No.: PCT/IL2021/050833

§ 371 Date: Jan. 11, 2023

(30) Foreign Application Priority Data
Jul. 13, 2020 (IL) 276015

(51) Int. Cl. G01S 13/72; G01S 17/66; G01S 13/58

(52) U.S. Cl. CPC G01S 13/72; G01S 17/66; G01S 13/589; G01S 2013/462

(57) ABSTRACT

A sensor which is configured to transmit electromagnetic waves towards a target, wherein the sensor is operable to detect, in response to the electromagnetic waves, first electromagnetic waves reflected by the target towards the sensor, second electromagnetic waves received by at least one redirecting device from the target and redirected by the redirecting device towards the sensor, wherein the first and second electromagnetic waves are usable to determine data representative of at least one of a position and a velocity of the target.

### TECHNICAL FIELD AND BACKGROUND

The presently disclosed subject matter relates to the field of target detection.

### GENERAL DESCRIPTION

In accordance with certain aspects of the presently disclosed subject matter, there is provided a sensor configured to transmit electromagnetic waves towards a target, wherein the sensor is operable to detect, in response to the electromagnetic waves, first electromagnetic waves reflected by the target towards the sensor, second electromagnetic waves received by at least one redirecting device from the target and redirected by the redirecting device towards the sensor, wherein the first and second electromagnetic waves are usable to determine data representative of at least one of a position and a velocity of the target.

In addition to the above features, the sensor according to this aspect of the presently disclosed subject matter can optionally comprise one or more of features (i) to (xv) below, in any technically possible combination or permutation:
i. at least some of the first electromagnetic waves are reflected by the target towards the sensor along a direct path between the target and the sensor;
ii. a redirection axis of the at least one redirecting device is controllable to redirect electromagnetic waves received from the target towards the sensor;
iii. the sensor is operatively connected to a processor and memory circuitry configured to determine data representative of two dimensional position of the target based at least on a time difference between transmitting electromagnetic waves by the sensor and receiving first electromagnetic waves by the sensor and a time difference between receiving the first electromagnetic waves by the sensor and receiving the second electromagnetic waves by the sensor;
iv. the sensor is operatively connected to a processor and memory circuitry configured to determine data representative of a two dimensional velocity vector of the target based on a frequency difference between electromagnetic waves transmitted by the sensor and first electromagnetic waves received by the sensor and a frequency difference between first electromagnetic waves received by the sensor and second electromagnetic waves received by the sensor;
v. the sensor is configured, upon detection of the target, to send a command to modify a redirection axis of the at least one redirecting device such that electromagnetic waves are redirected by the at least one redirecting device towards the sensor;
vi. the sensor is configured to track the target, wherein a redirection axis of the at least one redirecting device is controllable during tracking of the target, such that electromagnetic waves received by the at least one redirecting device from the target are redirected by the redirecting device towards the sensor;
vii. a redirection axis of the at least one redirecting device is controllable during a first phase based on position data determined based only on the first electromagnetic waves received by the sensor, and during a second phase based on position data determined based on at least first electromagnetic waves received from the target and second electromagnetic waves redirected by the redirecting device towards the sensor;
viii. the at least one redirecting device is a passive device;
ix. the at least one redirecting device includes at least one of a mirror and a phased array antenna;
x. the sensor is operable to detect, in response to the electromagnetic waves, first electromagnetic waves reflected by the target towards the sensor, second electromagnetic waves received by a first redirecting device from the target and redirected by the first redirecting device towards the sensor, third electromagnetic waves received by a second redirecting device from the target and redirected by the second redirecting device towards the sensor, wherein the first, second and third electromagnetic waves are usable to determine data representative of at least one of a position and a velocity of the target;
xi. the sensor is configured to directly illuminate the target with the electromagnetic waves and receive electromagnetic waves from at least three different directions: first electromagnetic waves reflected by the target, second electromagnetic waves reflected by the first redirecting device and third electromagnetic waves reflected by the second redirecting device;
xii. the sensor is operatively connected to a processor and memory circuitry configured to determine data representative of three dimensional position of the target based at least on a time difference between transmitting electromagnetic waves by the sensor and receiving first electromagnetic waves by the sensor, a time difference between receiving the first electromagnetic waves by the sensor and receiving the second electromagnetic waves by the sensor, and a time difference between receiving the first electromagnetic waves by the sensor and receiving the third electromagnetic waves by the sensor;
xiii. the sensor is operatively connected to a processor and memory circuitry configured to determine data representative of a three dimensional velocity vector of the target based on a frequency difference between electromagnetic waves transmitted by the sensor and first electromagnetic waves received by the sensor, a frequency difference between first electromagnetic waves received by the sensor and second electromagnetic waves received by the sensor, a frequency difference between first electromagnetic waves received by the sensor and third electromagnetic waves received by the sensor;
xiv. the sensor is configured to transmit at least one of determined over time positions and velocities of the target to a tracker; and
xv. the sensor has a single direction for transmitting of electromagnetic waves towards the target and multiple directions for receiving electromagnetic waves reflected by the target.

According to another aspect of the presently disclosed subject matter there is provided a system including a sensor as described above, and a first redirecting device, configured to redirect second electromagnetic waves received from the target towards the sensor.

According to some embodiments, the system includes a second redirecting device, configured to redirect third electromagnetic waves received from the target towards the sensor.

According to some embodiments, the system includes more than two redirecting devices, each configured to redirect electromagnetic waves received from the target towards the sensor.

In accordance with other aspects of the presently disclosed subject matter, there is provided a method including transmitting, by a sensor, electromagnetic waves towards a target, detecting first electromagnetic waves reflected by the target towards the sensor, detecting second electromagnetic waves received by a first redirecting device from the target and redirected by the first redirecting device towards the sensor, wherein the first and second electromagnetic waves are usable to determine data representative of at least one of a position and a velocity of the target.

In addition to the above features, the method according to this aspect of the presently disclosed subject matter can optionally comprise one or more of features (xvi) to (xxxi) below, in any technically possible combination or permutation:
xvi. at least some of the first electromagnetic waves are reflected by the target towards the sensor along a direct path between the target and the sensor;
xvii. the method comprises controlling a redirection axis of the at least one redirecting device to redirect electromagnetic waves received from the target towards the sensor;
xviii. the method comprises determining data representative of two dimensional position of the target based at least on a time difference between transmitting electromagnetic waves by the sensor and receiving first electromagnetic waves by the sensor and a time difference between receiving the first electromagnetic waves by the sensor and receiving the second electromagnetic waves by the sensor;
xix. the method comprises determining data representative of a two dimensional velocity vector of the target based on a frequency difference between electromagnetic waves transmitted by the sensor and first electromagnetic waves received by the sensor and a frequency difference between first electromagnetic waves received by the sensor and second electromagnetic waves received by the sensor;
xx. the method comprises sending by the sensor upon detection of the target, a command to modify a redirection axis of the at least one redirecting device such that electromagnetic waves are redirected by the at least one redirecting device towards the sensor;
xxi. the method comprises controlling a redirection axis of the at least one redirecting device during a first phase based on position data determined based only on the first electromagnetic waves received by the sensor, and during a second phase based on position data determined based on at least first electromagnetic waves received from the target and second electromagnetic waves redirected by the redirecting device towards the sensor;
xxii. the at least one redirecting device is a passive device;
xxiii. the at least one redirecting device includes at least one of a mirror and a phased array antenna;
xxiv. detecting first electromagnetic waves reflected by the target towards the sensor,
xxv. the method comprises detecting second electromagnetic waves received by a first redirecting device from the target and redirected by the first redirecting device towards the sensor, detecting third electromagnetic waves received by a second redirecting device from the target and redirected by the second redirecting device towards the sensor, wherein the first, second and third electromagnetic waves are usable to determine data representative of at least one of a position and a velocity of the target;
xxvi. the method comprises directly illuminating the target with the electromagnetic waves and receiving electromagnetic waves from at least three different directions: first electromagnetic waves reflected by the target, second electromagnetic waves reflected by the first redirecting device and third electromagnetic waves reflected by the second redirecting device;
xxvii. the method comprises determining data representative of three-dimensional position of the target based at least on a time difference between transmitting electromagnetic waves by the sensor and receiving first electromagnetic waves by the sensor, a time difference between receiving the first electromagnetic waves by the sensor and receiving the second electromagnetic waves by the sensor, and a time difference between receiving the first electromagnetic waves by the sensor and receiving the third electromagnetic waves by the sensor;
xxviii. the method comprises determining data representative of a three dimensional vector of velocity of the target based on a frequency difference between electromagnetic waves transmitted by the sensor and first electromagnetic waves received by the sensor, a frequency difference between first electromagnetic waves received by the sensor and second electromagnetic waves received by the sensor, a frequency difference between first electromagnetic waves received by the sensor and third electromagnetic waves received by the sensor;
xxix. the method comprises transmitting at least one of determined over time positions and velocities of the target to a tracker;
xxx. the method includes more than two redirecting devices; and
xxxi. the sensor has a single direction for transmitting of electromagnetic waves towards the target and multiple directions for receiving electromagnetic waves reflected by the target.

In accordance with other aspects of the presently disclosed subject matter, there is provided a non-transitory computer readable medium comprising instructions that, when executed by a processor and memory circuitry (PMC), cause the PMC to perform operations comprising obtaining data representative of first electromagnetic waves reflected by a target towards a sensor in response to electromagnetic waves sent by the sensor, obtaining data representative of second electromagnetic waves received by a first redirecting device from the target and redirected by the first redirecting device towards the sensor, and using the first and second electromagnetic waves to determine data representative of at least one of a position and velocity of the target.

According to some embodiments, the operations comprise obtaining data representative of third electromagnetic waves received by a second redirecting device from the target and redirected by the second redirecting device towards the sensor, and using the first, second and third electromagnetic waves to determine data representative of at least one of a position and velocity of the target.

According to some embodiments, the operations can optionally comprise one or more of features (xvi) to (xxxi) above, in any technically possible combination or permutation.

According to some embodiments, the proposed solution enables determination of data representative of a position of a target in a more precise and efficient way.

According to some embodiments, the proposed solution improves performance of an array configured to detect a target. In particular, according to some embodiments, the proposed solution eliminates the stringent constraints present in prior art systems involving an array, such as precise clock synchronization (in time and frequency) between multiple devices of the array.

According to some embodiments, the proposed solution improves operation of a multi-static array.

According to some embodiments, the proposed solution provides position and/or velocity of a target using an array including simple and efficient components.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an embodiment of a system which can be used to determine data representative of at least one of a position and a velocity of a target;

FIG. 2A illustrates an example of a first position of a redirecting device of the system of FIG. 1;

FIG. 2B illustrates an example of a second position of a redirecting device of the system of FIG. 1;

FIG. 3 illustrates another example of a redirecting device of the system of FIG. 1;

FIG. 4 illustrates an embodiment of a method of determining data representative of a position and/or of a velocity of the target using the architecture of FIG. 1;

FIG. 5 illustrates a position of a redirecting device allowing redirection of the received electromagnetic signals towards the sensor; and

FIGS. 6 and 7 illustrates possible computations that can be performed to determine at least one of a position and a velocity of the target;

FIG. 8 illustrates another embodiment of a system which can be used to determine data representative of at least one of a position and a velocity of a target;

FIG. 9 illustrates an embodiment of a method of determining data representative of a position and/or of a velocity of the target using the architecture of FIG. 8; and

FIG. 10 illustrates possible computations that can be performed to determine at least one of a position and a velocity of the target.

### DETAILED DESCRIPTION

In the following detailed description, numerous specific details are set forth in order to provide a thorough understanding of the invention. However, it will be understood by those skilled in the art that the presently disclosed subject matter can be practiced without these specific details. In other instances, well-known methods have not been described in detail so as not to obscure the presently disclosed subject matter.

Unless specifically stated otherwise, as apparent from the following discussions, it is appreciated that throughout the specification, discussions utilizing terms such as “detecting”, “obtaining”, “determining”, “controlling”, “sending” or the like, refer to the action(s) and/or process(es) of a processor and memory circuitry that manipulate and/or transform data into other data, said data represented as physical data, such as electronic, quantities and/or said data representing the physical objects.

The term “processor and memory circuitry” covers any computing unit or electronic unit with data processing circuitry that may perform tasks based on instructions stored in a memory, such as a computer, a server, a chip, a processor, etc. It encompasses a single processor or multiple processors, which may be located in the same geographical zone or may, at least partially, be located in different zones and may be able to communicate together.

Embodiments of the presently disclosed subject matter are not described with reference to any particular programming language. It will be appreciated that a variety of programming languages can be used to implement the teachings of the presently disclosed subject matter as described herein.

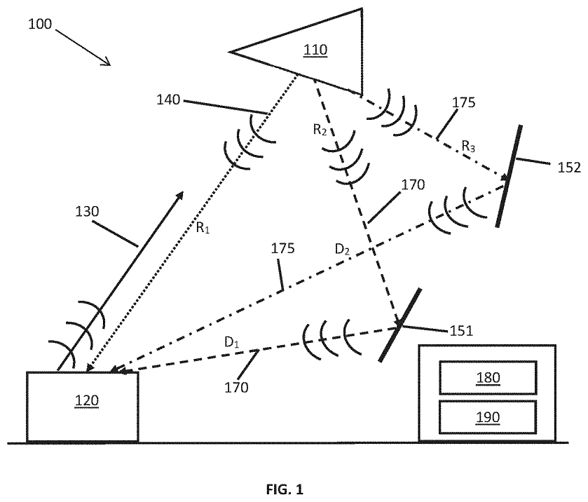

FIG. 1 is a schematic representation of an embodiment of a system 100, that can be used to detect a target 110 and determine data representative of the target.

System 100 includes a sensor 120 (in particular an active sensor 120), configured to transmit electromagnetic waves 130 towards a target 110 and to receive an electromagnetic signal reflected by the target 110. According to some embodiments, sensor 120 includes a radar equipped by antennas (e.g. collocated or divided antennas) for transmitting and receiving signals and/or a LIDAR. Electromagnetic waves 130 can be located e.g. in the radiofrequency or optical band, but this is not limitative.

In some embodiments, the sensor 120 is configured to scan space in order to detect a target, such as target 110.

Target 110 reflects at least some of the electromagnetic waves 130. According to some embodiments, at least some of the first electromagnetic waves reflected by the target 110 (referred to as 140) are sent back directly to the sensor 120 (e.g. along a direct path between the target 110 and the sensor 120, as shown e.g. in FIG. 1).

System 100 further includes at least two redirecting devices 151 and 152 (this is not limitative, and a larger number of redirecting devices can be used). As shown in FIG. 1, a first redirecting device 151 receives second electromagnetic waves 170 from the target 110. At least some of the second electromagnetic waves 170 are redirected by the first redirecting device 151 towards the sensor 120.

Similarly, a second redirecting device 152 receives third electromagnetic waves 175 from the target 110. At least some of the second electromagnetic waves 175 are redirected by the second redirecting device 152 towards the sensor 120.

Sensor 120 detects therefore at least the first electromagnetic waves 140 (directly from the target 110), the second electromagnetic waves 170 (redirected by the first redirecting device 151) and the third electromagnetic waves 175 (redirected by the second redirecting device 152).

According to some embodiments, the redirecting device(s) (e.g. 151 and/or 152) can include e.g. mechanical antenna(s), reflector(s) (such as an electro-mechanical mirror and/or a horn) or electronically steerable antenna(s) (such as a phased array antenna).

According to some embodiments, the redirecting device(s) (e.g. 151 and/or 152) are passive devices that do not generate electromagnetic waves by themselves, but rather redirect the received electromagnetic waves to a different direction.

As explained hereinafter, the first electromagnetic waves 140, the second electromagnetic waves 170 and the third electromagnetic waves 175 are usable to determine data representative of at least one of a position and a velocity of the target 110. In particular in some embodiments, a three dimensional position and/or a three dimensional velocity vector can be determined at each instant of time (in contradiction to a classical radar which cannot determine a velocity vector along certain directions),

According to some embodiments, sensor 120 can include and/or can communicate with a processor and memory circuitry (see processing unit 180 and associated memory 190), which can perform various processing tasks, as explained hereinafter.

According to some embodiments, system 100 includes a single active sensor, and does not require additional active sensors to detect the target and determine data representative thereof.

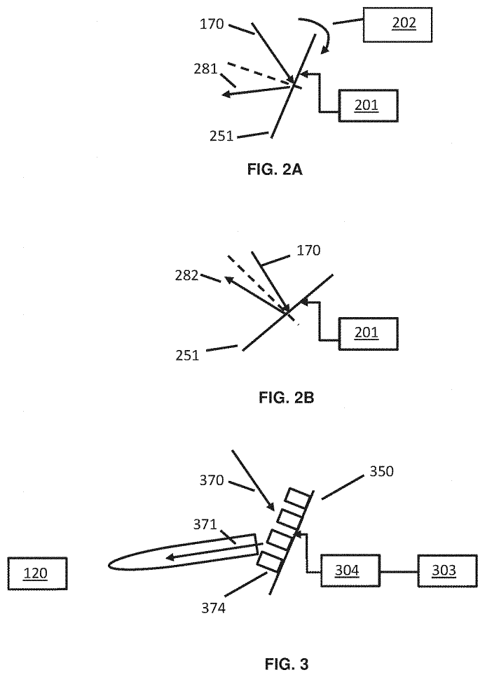

Attention is now drawn to FIGS. 2A and 2B, which depict a non-limitative example of a redirecting device, referred to as 251.

In this example, the redirecting device 251 is a mirror. Orientation 202 of the mirror 251 is controlled along two axes (e.g. pan and tilt) by a motor 201. The motor 201 can receive commands to modify orientation of the mirror 251.

In a first orientation of the mirror 251 (FIG. 2A), the electromagnetic waves 170 received from the target are redirected by the mirror 251 along a first redirection axis 281.

In a second orientation of the mirror 251 (see FIG. 2B—as mentioned above, motor 202 is operable to modify the orientation of the mirror 251, e.g. upon reception of an external command), the electromagnetic waves 170 received from the target are redirected by the mirror 251 along a second redirection axis 282.

As explained hereinafter, the redirection axis of the mirror 251 can be controlled (by controlling orientation of the mirror along one or more axes) such that the electromagnetic waves received from the target and redirected by the redirecting device, are redirected towards the sensor 120.

Attention is drawn to FIG. 3, which depicts another possible example of a redirecting device, referred to as 350.

In this non-limitative example, the redirecting device 350 is a phased array antenna. Upon reception of electromagnetic waves 370 reflected by the target, the phased array antenna can be controlled such that the redirection axis (in this case this corresponds to the axis 371 of the beam emitted by the phased array antenna) is oriented towards the sensor 120. Steering of the beam emitted by the phased array antenna can be carried out electronically, without requiring moving the individual antennas 374 of the phased array antenna. This can be performed by controlling the phase of the individual elements 374 using one or more phase shifters 304 controlled by a controller 303, such that the electromagnetic waves (e.g. radio waves) from the individual elements 374 work together to increase the radiation in the redirection axis, while cancelling radiation in other directions.

According to some embodiments, the phased array antenna is a passive phased array.

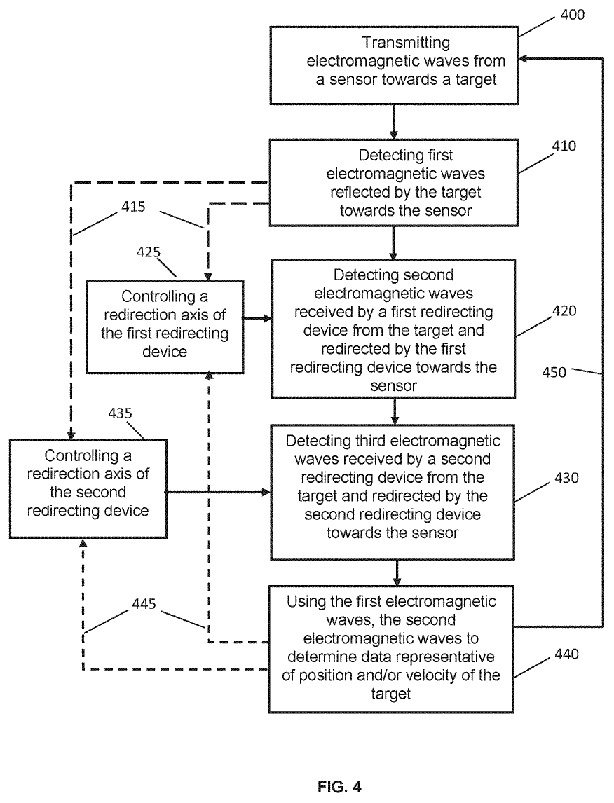

Attention is now drawn to FIG. 4. According to some embodiments, the method of FIG. 4 can rely e.g. on the architecture described with reference to FIG. 1.

The method includes (operation 400) transmitting electromagnetic waves from a sensor (such as sensor 120) towards a target (e.g. 110). According to some embodiments, the method can include directly illuminating the target with the electromagnetic waves (without a relay between the sensor and the target).

The method includes detecting (operation 410), by the sensor, first electromagnetic waves reflected by the target towards the sensor (as mentioned above, according to some embodiments, at least some of the first electromagnetic waves are reflected by the target along a direct path between the target and the sensor).

The method includes detecting (operation 420), by the sensor, second electromagnetic waves received by a first redirecting device from the target and redirected by the first redirecting device towards the sensor (as mentioned above, at least some of the electromagnetic waves received by the first redirecting device from the target, are redirected towards the sensor).

The method includes detecting (operation 430), by the sensor, third electromagnetic waves received by a second redirecting device from the target and redirected by the second redirecting device towards the sensor (as mentioned above, at least some of the electromagnetic waves received by the second redirecting device from the target, are redirected towards the sensor).

According to some embodiments, in order to ensure that the second electromagnetic waves are redirected towards the sensor, the method can include controlling (operation 425) a redirection axis of the first redirecting device.

According to some embodiments, in order to ensure that the third electromagnetic waves are redirected towards the sensor, the method can include controlling (operation 435) a redirection axis of the second redirecting device.

In some embodiments, this control is performed by the sensor, which sends a command (e.g. through wireless communication) to the first and second redirecting devices. This is not limitative, and in some embodiments, the redirecting devices can be controlled by a processor and memory circuitry (which can be external to the sensor and can e.g. communicate, directly or indirectly, with the sensor).

According to some embodiments, controlling of redirection by the redirecting device(s) can be performed as a two-phase process. In a first phase, first commands (see reference 415 in FIG. 4) are determined based on data collected by sensor 120 by receiving only the first electromagnetic waves (and not the second and third electromagnetic waves, which may not have been yet received in the first phase). In particular, sensor 120 can use the first electromagnetic waves to provide data informative of range and/or angular position of the target, which can be used in turn to control the redirection axis of each of the redirecting devices.

In a second phase, subsequent commands (see reference 445 in FIG. 4) can be determined e.g. while the target is tracked by the full system using first, second and third electromagnetic waves. In particular, as explained hereafter, the first, second and third electromagnetic waves can be used to determine 3D position and/or 3D velocity of the target, which can be used to control the redirection axis of each of the redirecting devices.

In some embodiments, a continuous control of the redirecting axis of the redirecting device is performed, and in other embodiments, a control is performed from time to time (frequency of the control can depend, in particular, on the angular velocity of a line of sight from the redirecting device to the target).

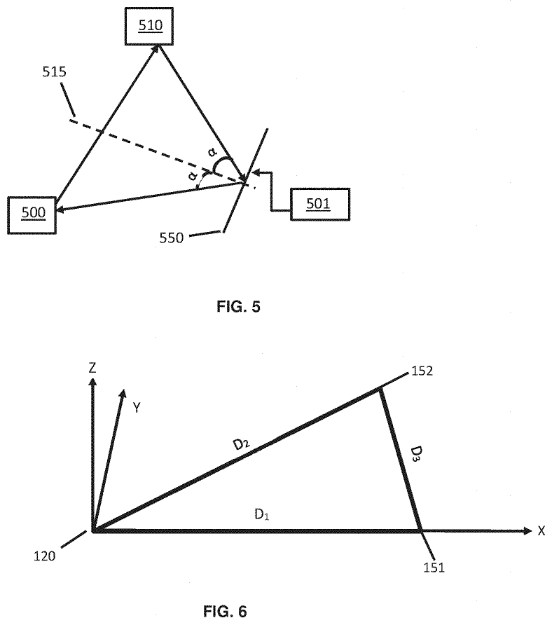

As mentioned above, in some embodiments, a first indication of the position of the target is obtained by the sensor, and can be used to adjust the redirection axes of the redirecting devices. For example, in the case of a mirror, and as shown in FIG. 5, orientation of the mirror 550 can be controlled (using e.g. a motor 501 controlling the mirror 550) such that a main axis 515 of the mirror 550 is aligned with a mean line (bisectrix) of a triangle defined by sensor 500, target 510 and mirror 550.

The method can further include (operation 440) using the first, the second and the third electromagnetic waves sensed by the sensor to determine data representative of at least one of a position and a velocity of the target. Since the first, second and third electromagnetic waves are sensed by the same sensor, there is no need to perform an accurate clock synchronization between a clock of the sensor and a clock of another devices in the array. Operation 440 can be performed e.g. by a processor and memory circuitry located in the sensor, and/or by an external processor and memory circuitry.

According to some embodiments, data representative of a position of the target is determined based on a range measured by the sensor (e.g. radar) 120, a time difference of arrival between the first and second electromagnetic waves detected by the sensor, and a time difference of arrival between the first and the third electromagnetic waves detected by the sensor.

According to some embodiments, a full 3D instantaneous position of the target at a given point of time can be determined using the following equations (these equations are not limitative):

c|t₂−t₁|=2R₁ (Equation 1)

c|t₃−t₁|=R₁+R₂+D₁ (Equation 2)

c|t₄−t₁|=R₁+R₃+D₂ (Equation 3)

In these equations, c is the velocity of light, t₁ is the time at which the electromagnetic waves are transmitted by the sensor, t₂ is the time at which the first electromagnetic waves are sensed by the sensor, t₃ is the time at which the second electromagnetic waves (redirected to the sensor by the first redirecting device 151 in FIG. 1) are sensed by the sensor, t₄ is the time at which the third electromagnetic waves (redirected to the sensor by the second redirecting device 152 in FIG. 1) are sensed by the sensor, R₁ is the distance between the sensor and the target (see FIG. 1), R₂ is the distance between the target and the first redirecting device (151, see FIG. 1), D₁ is the distance between the first redirecting device and the sensor (D₁ is known), R₃ is the distance between the target and the second redirecting device (152, see FIGS. 1), and D₂ is the distance between the second redirecting device and the sensor (D₂ is known).

Determination of target position by usage of R₁, R₁+R₂ and R₁+R₃ has a following geometry interpretation: R₁ defines the radius of a sphere (which centre is sensor 120) of target possible locations, R₁+R₂ defines a first ellipsoid of target possible locations (sensor 120 and the first redirecting device 151 are the foci of the first ellipsoid), and R₁+R₃ defines a second ellipsoid of target possible locations (sensor 120 and the second redirecting device 152 are the foci of the second ellipsoid).

The intersection of the sphere and each of the two ellipsoids generates two circles of possible target locations. The intersection of these two circles provides two points corresponding to the possible target positions. One of the points (called “ghost target”) is eliminated by a constraint on Earth surface (one of a target possible location points is located above Earth surface and the second under the plane defined by sensor 120, first redirecting device 151 and second redirecting device 152).

Algebraic equations are provided hereinafter in order to determine 3D position and/or 3D velocity of the target (these equations are not limitative).

Attention is now drawn to FIG. 6. The known distance between the first and the second redirecting devices is denoted as D₃.

Assume that the origin of a canonical right Cartesian coordinates system (defined by axes X, Y, Z) is located at sensor 120 (see FIG. 6). As shown in FIG. 6, axis X passes through the first redirecting device 151, axis Y is orthogonal to axis X, while a plane XY contains sensor 120, the first redirecting device 151 and the second redirecting device 152 (see FIG. 6). Axis Z is orthogonal to both X and Y axes.

In this coordinate system, sensor 120 has coordinates (0,0,0), the first redirecting device 151 has coordinates (D₁,0,0) and the second redirecting device 152 has coordinates (X₂,Y₂,0).

Coordinate Y₂ can be obtained by usage of a Heron formula for triangle area. The area S_{Δ} of a triangle defined by points 120, 151 and 152 can be expressed in as follows:

$${S}_{Δ} = \frac{1}{2} * {Y}_{2} * {D}_{1} = \sqrt{p * ( p - {D}_{1} ) * ( p - {D}_{2} ) * ( p - {D}_{3} )} \qquad ( Equation 4 )$$

In Equation 4,

$$p = \frac{1}{2} * ( {D}_{1} + {D}_{2} + {D}_{3} ) .$$

As a consequence:

$${Y}_{2} = \pm 2 * \frac{\sqrt{p * ( p - {D}_{1} ) * ( p - {D}_{2} ) * ( p - {D}_{3} )}}{{D}_{1}} \qquad ( Equation 5 )$$

The sign of coordinate Y₂ depends on a deployment of the second redirecting device 152 relatively to the X axis.

Coordinate X₂ can be obtained by following expression:

$${X}_{2} = \pm \sqrt{{D}_{2}^{2} - {Y}_{2}^{2}} \qquad ( Equation 6 )$$

X₂ is positive if the triangle (as shown in FIG. 6) has an acute angle (less than 90 degrees) at vertex 120 and negative if the triangle has an obtuse angle at vertex 120.

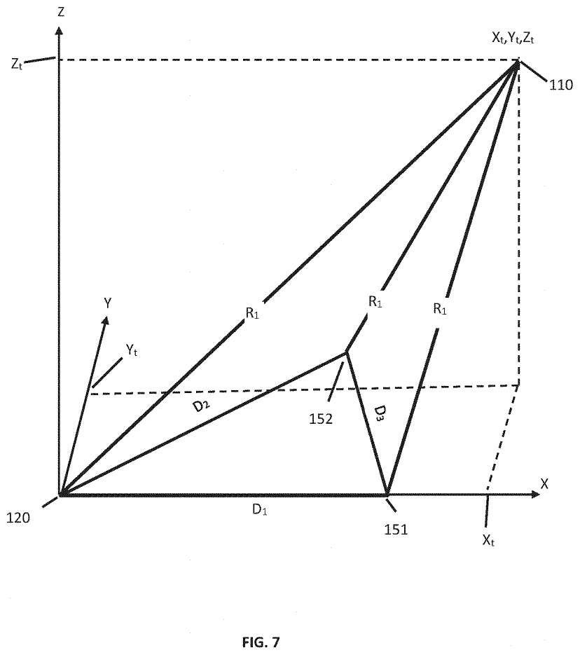

Attention is now drawn to FIG. 7. Target 110, the sensor 120, the first redirecting device 151 and the second redirecting device 152 form a tetrahedron (pyramid). In particular, the sensor 120 and the redirecting devices 151, 152 define the base of this tetrahedron and the target 110 is located at its apex. The six edges of this tetrahedron are either known (D₁, D₂, D₃) or measured (R₁, R₂, R₃). The unknown coordinates of the target 110 are noted Xₜ, Yₜ, Zₜ.

The following set of equations expresses the relationships between the target coordinates and tetrahedron edges:

R₁²=Xₜ²+Yₜ²+Z₂² (Equation 7)

R₂²=(Xₜ−D₁)²+Yₜ²+Zₜ² (Equation 8)

R₃²=(Xₜ−X₂)²+(Yₜ−Y₂)+Zₜ (Equation 9)

X₂ and Y₂ are obtained by Equations 5 and 6.

X₅ coordinate of the target can be extracted from Equations 7 and 8:

$${X}_{t} = \frac{{R}_{1}^{2} - {R}_{2}^{2} + {D}_{1}^{2}}{2 * {D}_{1}} \qquad ( Equation 10 )$$

Yₜ coordinate of the target can be extracted from Equations 7 and 9:

$${Y}_{t} = \frac{{R}_{1}^{2} - {R}_{3}^{2} + {D}_{2}^{2} - 2 * {X}_{t} * {X}_{2}}{2 * {Y}_{2}} \qquad ( Equation 11 )$$

Zₜ coordinate of the target can be extracted from Equation 7 as follows (Xₜ and Yₜ have been determined based on Equations 10 and 11):

Zₜ=±\sqrt{R₁²−Xₜ²−Tₜ²} (Equation 12)

A positive sign of Zₜ coordinate corresponds to the fact that the target is located above the plane which includes sensor 120, the first redirecting device 151 and the second redirecting device 152. A negative sign of Zₜ coordinate corresponds to the fact that the target is located below the above mentioned plane. If the sensor 120 is located on ground, a negative sign is indicative of a ghost target.

According to some embodiments, a full 3D instantaneous vector of velocity of the target at a given point of time can be determined based on three Doppler sifts Δf₁, Δf₂ and Δf₃ measured by a sensor 120. A Doppler shift Δf₁ is defined as a difference between a frequency f₀ of the electromagnetic waves 130 transmitted by the sensor 120 towards the target 110 and a frequency f₁ of the first electromagnetic waves 140 detected by the sensor 120. A Doppler shift Δf₂ is defined as a difference between frequency f₀ and a frequency f₂ of the second electromagnetic waves 170 redirected by the first redirecting device 151 and detected by the sensor 120. A Doppler shift Δf₃ is defined as a difference between frequency f₀ and a frequency f₃ of the third electromagnetic waves 175 redirected by the second redirecting device 152 and detected by the sensor 120.

Doppler shift can be calculated by the following equation:

$$Δ f = 2 * {f}_{0} \frac{V}{c - V} \approx 2 * {f}_{0} \frac{V}{c} \qquad ( Equation 13 )$$

In Equation 13, c is speed of light and V is a projection of target velocity. In Equation 13, the relevant projection V₁ of the target velocity measured for the first electromagnetic waves 140 is a projection of the target velocity on a line of sight between the sensor 120 and the target 110. The relevant projection V₂ of the target velocity for the second electromagnetic waves 170 is a projection of the target velocity on a line from the middle point between the sensor 120 and the first redirecting device 151 to the target (similar to the Doppler shift measured by bi-static radars). The relevant projection V₃ of the target velocity for the third electromagnetic waves 175 is a projection of the target velocity on the line of sight from the middle point between the sensor 120 and the second redirecting device 152 to the target 110.

Assume that target velocity is Vt, for which three components Vtₓ, Vt_{y} and Vt_{z} need to be determined.

The three projections V₁, V₂ and V₃ of the target velocity provide a set of linear equations allowing reconstruction of target velocity Vt components:

$${V}_{1} = \frac{c * Δ {f}_{1}}{2 * {f}_{0}} , {V}_{2} = \frac{c * Δ {f}_{2}}{2 * {f}_{0}} , {V}_{3} = \frac{c * Δ {f}_{3}}{2 * {f}_{0}} \qquad ( Equation 14 )$$

The projection V₁ of target velocity Vt on the line of sight from the sensor 120 to the target 110 can be expressed as follows:

$${V}_{1} = \frac{{Vt}_{x} * {X}_{t} + {Vt}_{y} * {Y}_{t} + {Vt}_{z} * {Z}_{t}}{{R}_{1}} \qquad ( Equation 15 )$$

The projection V₂ of target velocity Vt on the line from the middle point between the sensor 120 and the first redirecting device 151 to the target 110 can be expressed as follows:

$${V}_{2} = \frac{{Vt}_{x} * ( {X}_{t} - \frac{{D}_{1}}{2} ) + {Vt}_{y} * {Y}_{t} + {Vt}_{z} * {Z}_{t}}{\sqrt{{( {X}_{t} - \frac{{D}_{1}}{2} )}^{2} + {Y}_{t}^{2} + {Z}_{t}^{2}}} \qquad ( Equation 16 )$$

The projection V₃ of target velocity Vt on the line from the middle point between the sensor 120 and the second redirecting device 152 to the target 110 can be expressed as follows:

$${V}_{3} = \frac{{Vt}_{x} * ( {X}_{t} - \frac{{X}_{2}}{2} ) + {Vt}_{y} * ( {Y}_{t} - \frac{{Y}_{2}}{2} ) + {Vt}_{z} * {Z}_{t}}{\sqrt{{( {X}_{t} - \frac{{X}_{2}}{2} )}^{2} + {( {Y}_{t} - \frac{{Y}_{2}}{2} )}^{2} + {Z}_{t}^{2}}} \qquad ( Equation 17 )$$

Vtₓ can be extracted from Equations 15 and 16:

$${Vt}_{x} = 2 * \frac{{V}_{1} * {R}_{1} - {V}_{2} * \sqrt{{( {X}_{t} - \frac{{D}_{1}}{2} )}^{2} + {Y}_{t}^{2} + {Z}_{t}^{2}}}{{D}_{1}} \qquad ( Equation 18 )$$

Vt_{y} can be extracted from Equations 15 and 17:

$${Vt}_{y} = 2 * \frac{\begin{matrix}{V}_{1} * {R}_{1} - {Vt}_{x} * \frac{{X}_{2}}{2} - {V}_{3} * \\ \sqrt{{( {X}_{t} - \frac{{X}_{2}}{2} )}^{2} + {( {Y}_{t} - \frac{{Y}_{2}}{2} )}^{2} + {Z}_{t}^{2}}\end{matrix}}{{Y}_{2}} \qquad ( Equation 19 )$$

In Equation 19, Vtₓ is obtained from Equation 18.

Vt_{z} can be extracted from Equation 15:

$${Vt}_{z} = \frac{{V}_{1} * {R}_{1} - {Vt}_{x} * {X}_{t} - {Vt}_{y} * {Y}_{t}}{{Z}_{t}} \qquad ( Equation 20 )$$

In Equation 20, Vtₓ and Vt_{y} are obtained from Equations 18 and 19 respectively.

It is understood that data sensed by the sensor over time (first, second and third electromagnetic waves) is usable to determine data representative of at least one of position and velocity of the target over time.

In particular, the method depicted in FIG. 4 can be repeated over time (see reference 450 in FIG. 4) in order to obtain at least one of 3D position and 3D velocity of the target. Position and/or velocity of the target determined over time can be used as a raw data for different filters and/or trackers. These filters and/or trackers can be used for different tasks, such as, but not limited to, reduction of measurement noise, classification of the target, detection of the target manoeuvers, etc.

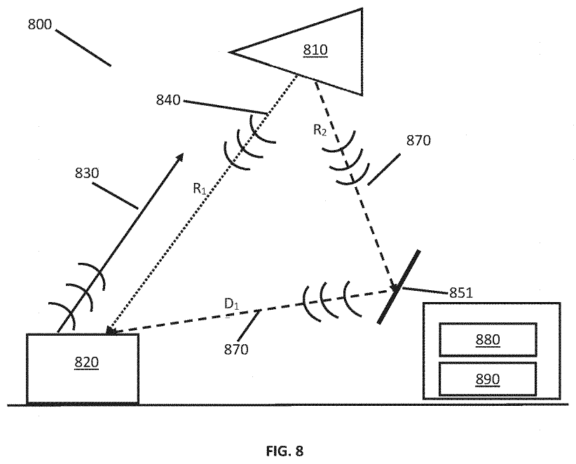

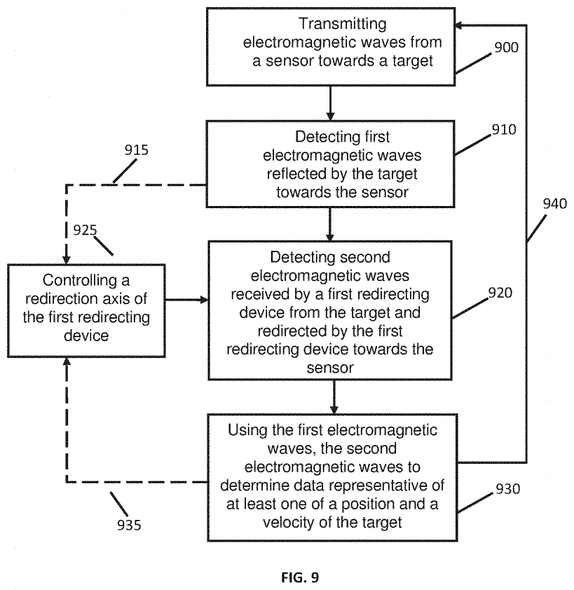

Attention is now drawn to FIG. 8 which depicts a system 800, which is a two dimensional variant of the system 100 of FIG. 1, in order to determine data informative of a target 810 (similar to target 110).

There are several cases in which kinematic behaviour of the target is associated with several constraints and therefore the measurement system is not required to obtain 3D position and/or 3D vector velocity. For example, a constraint of see surface alleviates the need of determining “Z coordinate” of a vessel's position and/or upper component of vessel's velocity. Several aerial and/or space applications also have some constraints that eliminate a need for full (3D) state vector measurements. Examples of such constraints may include e.g. assuming of non-manoeuvrability of a target, assuming that the target is maintained at a predefined altitude and/or within a predefined plane during its flight, etc. According to some embodiments, in these examples, determination of four parameters (e.g. two position coordinates and two components of velocity vector) are enough for target state vector definition.

System 100 includes a sensor 820, similar to sensor 120, which is therefore not described again (one can refer to the description above). Sensor 820 is configured to transmit electromagnetic waves 830 towards a target 810.

Target 810 reflects at least some of the electromagnetic waves 830. According to some embodiments, at least some of the first electromagnetic waves reflected by the target 810 (referred to as 840) are sent back directly to the sensor 820 (e.g. along a direct path between the target 810 and the sensor 820, as shown e.g. in FIG. 8).

In this embodiment, system 810 includes a single redirecting device 851. The redirecting device 851 is similar to the redirecting device 151 and is therefore not described again. As shown in FIG. 8, the redirecting device 851 receives second electromagnetic waves 870 from the target 810. At least some of the second electromagnetic waves 870 are redirected by the redirecting device 851 towards the sensor 820.

As explained hereinafter, the first electromagnetic waves 840 and the second electromagnetic waves 870 are usable to determine data representative of at least one of a position and a velocity of the target 810. By tracking the target over time, a 2D position and/or 2D velocity vector can be determined as explained hereinafter.

According to some embodiments, system 800 includes a single active sensor, and does not require additional active sensors to detect the target and determine data representative thereof.

Attention is drawn to FIG. 9.

The method includes (operation 900) transmitting electromagnetic waves from a sensor (such as sensor 820) towards a target (e.g. 810). According to some embodiments, the method can include directly illuminating the target with the electromagnetic waves (without a relay between the sensor and the target).

The method includes detecting (operation 910), by the sensor, first electromagnetic waves reflected by the target towards the sensor (as mentioned above, according to some embodiments, at least some of the first electromagnetic waves are reflected by the target along a direct path between the target and the sensor).

The method includes detecting (operation 920), by the sensor, second electromagnetic waves received by a redirecting device from the target and redirected by the redirecting device towards the sensor (as mentioned above, at least some of the electromagnetic waves received by the first redirecting device from the target, are redirected towards the sensor).

According to some embodiments, in order to ensure that the first electromagnetic waves are redirected towards the sensor, the method can include controlling (operation 925) a redirection axis of the redirecting device. According to some embodiments, and as mentioned above, the first commands of a redirection axis of the first redirecting device (see reference 915 in FIG. 9) can be derived from the information derived from receiving first electromagnetic waves only (which allows first estimation of e.g. range and/or angular position of the target) and subsequent commands of the redirection axis of the first redirecting device (see reference 935 in FIG. 9) can be derived from the tracking information of the target derived from receiving first and second electromagnetic waves (which allow computing 2D position and/or velocity of the target).

In some embodiments, control of the redirecting device is performed by the sensor, which sends a command (e.g. through wireless communication) to the redirecting device. This is not limitative, and in some embodiments, the redirecting device can be controlled by a processor and memory circuitry (which can be external to the sensor and can e.g. communicate, directly or indirectly, with the sensor).

This control can be performed e.g. while the target is tracked by the sensor. In some embodiments, a continuous control of the redirecting axis of the redirecting device is performed, and in other embodiments, a control is performed from time to time (frequency of the control can depend, in particular, on the angular velocity of a line of sight from the redirecting device to the target).

As mentioned above, in some embodiments, a first indication of the position of the target is obtained by the sensor, and can be used to adjust the redirection axis of the redirecting devices. For example, in the case of a mirror, and as shown in FIG. 5, orientation of the mirror 550 can be controlled (using e.g. a motor 501 controlling the mirror 550) such that a main axis 515 of the mirror 550 is aligned with a mean line (bisectrix) of a triangle defined by sensor 500, target 510 and mirror 550.

The method can further include (operation 930) using the first and the second electromagnetic waves sensed by the sensor to determine data representative of at least one of a position and a velocity of the target.

According to some embodiments, data representative of a position of the target is determined based on a time difference between transmitting electromagnetic waves by the sensor and receiving first electromagnetic waves by the sensor and a time difference between receiving the first electromagnetic waves by the sensor and receiving the second electromagnetic waves by the sensor.

According to some embodiments, and as shown in FIG. 9 (see reference 910), the method can be repeated over time, while the target is moving. As a consequence, and as explained hereinafter, this can be used to determine 2D position of the target, and/or 2D velocity vector of the target over time.

According to some embodiments, data representative of a position of the target is determined based on a range measured by the sensor (e.g. radar) 820 and a time difference of arrival between the first and second electromagnetic waves detected by the sensor.

According to some embodiments, a 2D instantaneous position of the target at a given point of time can be determined using the following equations (these equations are not limitative):

c|t₂−t₁|=2R₁ (Equation 20)

c|t₃−t₁|=R₁+R₂+D₁ (Equation 21)

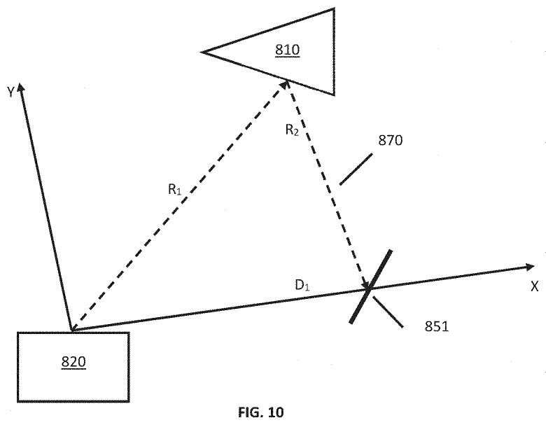

Assume that the origin of a canonical right Cartesian coordinates system (defined by axes X, Y) is located at sensor 820 (see FIG. 10). As shown in FIG. 10, axis X passes through the redirecting device 851, axis Y is orthogonal to axis X, while a plane XY contains sensor 820, the redirecting device 851 and the target 810 (see FIG. 10).

In this coordinate system, sensor 820 has coordinates (0,0), the redirecting device 851 has coordinates (D₁,0) and the target 810 has coordinates (Xₜ, Yₜ).

Coordinates of the target (Xₜ,Yₜ) can be obtained e.g. according the method described above by usage of a Heron formula for triangle area. The area S_{Δ} of a triangle defined by points 820, 851 and 810 can be expressed in as follows:

$${S}_{Δ} = \frac{1}{2} * {Y}_{t} * {D}_{1} = \sqrt{p * ( p - {D}_{1} ) * ( p - {R}_{1} ) * ( p - {R}_{2} )} \qquad ( Equation 22 )$$

In Equation 22, p=½*(D₁+R₁+R₂).

As a consequence:

$${Y}_{t} = \pm 2 * \frac{\sqrt{p * ( p - {D}_{1} ) * ( p - {R}_{1} ) * ( p - {R}_{2} )}}{{D}_{1}} \qquad ( Equation 23 )$$

The sign of coordinate Yₜ depends on a position of the target 810 relatively to the X axis.

Coordinate Xₜ can be obtained by following expression:

$${X}_{t} = \pm \sqrt{{R}_{1}^{2} - {Y}_{t}^{2}} \qquad ( Equation 24 )$$

Xₜ is positive if the triangle (as shown in FIG. 10) has an acute angle (less than 90 degrees) at vertex 820 and negative if the triangle has an obtuse angle at vertex 820.

According to some embodiments, a 2D instantaneous vector of velocity of the target at a given point of time can be determined based on two Doppler shifts Δf₁ and Δf₂ measured by sensor 820. A Doppler shift Δf₁ is defined as a difference between a frequency f₀ of the electromagnetic waves 830 transmitted by the sensor 820 towards the target 810 and a frequency f₁ of the first electromagnetic waves 840 detected by the sensor 820. A Doppler shift Δf₂ is defined as a difference between frequency f₀ and a frequency f₂ of the second electromagnetic waves 870 redirected by the redirecting device 851 and detected by the sensor 820.

Doppler shift can be calculated by Equation 13 mentioned above.

The relevant projection V₁ of the target velocity measured for the first electromagnetic waves 840 is a projection of the target velocity on a line of sight between the sensor 820 and the target 810. The relevant projection V₂ of the target velocity for the second electromagnetic waves 870 is a projection of the target velocity on a line from the middle point between the sensor 820 and the redirecting device 851 to the target (similar to the Doppler shift measured by bi-static radars).

Assume that target velocity is Vt, for which two components Vtₓ and Vt_{y} need to be determined.

The two projections V₁ and V₂ of the target velocity provide a set of linear equations allowing reconstruction of target velocity Vt components:

$${V}_{1} = \frac{c * Δ {f}_{1}}{2 * {f}_{0}} , {V}_{2} = \frac{c * Δ {f}_{2}}{2 * {f}_{0}} \qquad ( Equations 25 )$$

The projection V₁ of target velocity Vt on the line of sight from the sensor 820 to the target 810 can be expressed as follows:

$${V}_{1} = \frac{{Vt}_{x} * {X}_{t} + {Vt}_{y} * {Y}_{t}}{{R}_{1}} \qquad ( Equation 26 )$$

The projection V₂ of target velocity Vt on the line from the middle point between the sensor 820 and the redirecting device 851 to the target 810 can be expressed as follows:

$${V}_{2} = \frac{{Vt}_{x} * ( {X}_{t} - \frac{{D}_{1}}{2} ) + {Vt}_{y} * {Y}_{t}}{\sqrt{{( {X}_{t} - \frac{{D}_{1}}{2} )}^{2} + {Y}_{t}^{2}}} \qquad ( Equation 27 )$$

Vtₓ can be extracted from Equations 26 and 27:

$${Vt}_{x} = 2 * \frac{{V}_{1} * {R}_{1} - {V}_{2} * \sqrt{{( {X}_{t} - \frac{{D}_{1}}{2} )}^{2} + {Y}_{t}^{2}}}{{D}_{1}} \qquad ( Equation 28 )$$

Vt_{y} can be extracted from Equation 26:

$${Vt}_{y} = 2 * \frac{{V}_{1} * {R}_{1} - {Vt}_{x} * {X}_{t}}{{Y}_{t}} \qquad ( Equation 29 )$$

In Equation 29, Vtₓ is obtained from Equation 28.

Therefore, both Vtₓ and Vt_{y}, which are the components of the target vector velocity Vt, are obtained.

As already mentioned above, position and/or velocity of the target determined over time can be used as a raw data for different filters and/or trackers. These filters and/or trackers can be used for different tasks, such as, but not limited to, reduction of measurement noise, classification of the target, detection of the target manoeuvers, etc.

The invention contemplates a computer program being readable by a computer for executing at least part of one or more methods of the invention. The invention further contemplates a machine-readable memory tangibly embodying a program of instructions executable by the machine for executing at least part of one or more methods of the invention.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A sensor configured to transmit electromagnetic waves towards a target, wherein the sensor is operable to detect, in response to the electromagnetic waves:
first electromagnetic waves reflected by the target towards the sensor,
second electromagnetic waves received by at least one redirecting device from the target and redirected by the redirecting device towards the sensor, wherein the first and second electromagnetic waves are usable to determine data representative of at least one of a position and a velocity of the target.

2. The sensor of claim 1, wherein at least some of the first electromagnetic waves are reflected by the target towards the sensor along a direct path between the target and the sensor.

3. The sensor of claim 1, wherein a redirection axis of the at least one redirecting device is controllable to redirect electromagnetic waves received from the target towards the sensor.

4. The sensor of claim 1, operatively connected to a processor and memory circuitry configured to determine data representative of two dimensional position of the target based at least on a time difference between transmitting electromagnetic waves by the sensor and receiving first electromagnetic waves by the sensor and a time difference between receiving the first electromagnetic waves by the sensor and receiving the second electromagnetic waves by the sensor.

5. The sensor of claim 1, operatively connected to a processor and memory circuitry configured to determine data representative of a two dimensional velocity vector of the target based on a frequency difference between electromagnetic waves transmitted by the sensor and first electromagnetic waves received by the sensor and a frequency difference between first electromagnetic waves received by the sensor and second electromagnetic waves received by the sensor.

6. The sensor of claim 1, wherein the sensor is configured, upon detection of the target, to send a command to modify a redirection axis of the at least one redirecting device such that electromagnetic waves are redirected by the at least one redirecting device towards the sensor.

7. The sensor of claim 1, wherein the sensor is configured to track the target, wherein a redirection axis of the at least one redirecting device is controllable during tracking of the target, such that electromagnetic waves received by the at least one redirecting device from the target are redirected by the redirecting device towards the sensor.

8. The sensor of claim 1, wherein a redirection axis of the at least one redirecting device is controllable during a first phase based on position data determined based only on the first electromagnetic waves received by the sensor, and during a second phase based on position data determined based on at least first electromagnetic waves received from the target and second electromagnetic waves redirected by the redirecting device towards the sensor.

9. The sensor of claim 1, wherein the at least one redirecting device is a passive device, or the at least one redirecting device includes at least one of a mirror and a phased array antenna.

10. (canceled)

11. The sensor of claim 1, operable to detect, in response to the electromagnetic waves:
first electromagnetic waves reflected by the target towards the sensor,
second electromagnetic waves received by a first redirecting device from the target and redirected by the first redirecting device towards the sensor,
third electromagnetic waves received by a second redirecting device from the target and redirected by the second redirecting device towards the sensor,
wherein the first, second and third electromagnetic waves are usable to determine data representative of at least one of a position and a velocity of the target.

12. The sensor of claim 11, configured to directly illuminate the target with the electromagnetic waves and receive electromagnetic waves from at least three different directions: first electromagnetic waves reflected by the target, second electromagnetic waves reflected by the first redirecting device and third electromagnetic waves reflected by the second redirecting device.

13. The sensor of claim 11, operatively connected to a processor and memory circuitry configured to determine data representative of three dimensional position of the target based at least on a time difference between transmitting electromagnetic waves by the sensor and receiving first electromagnetic waves by the sensor, a time difference between receiving the first electromagnetic waves by the sensor and receiving the second electromagnetic waves by the sensor, and a time difference between receiving the first electromagnetic waves by the sensor and receiving the third electromagnetic waves by the sensor.

14. The sensor of claim 11, operatively connected to a processor and memory circuitry configured to determine data representative of a three dimensional velocity vector of the target based on a frequency difference between electromagnetic waves transmitted by the sensor and first electromagnetic waves received by the sensor, a frequency difference between first electromagnetic waves received by the sensor and second electromagnetic waves received by the sensor, a frequency difference between first electromagnetic waves received by the sensor and third electromagnetic waves received by the sensor.

15. The sensor of claim 1, configured to transmit at least one of determined over time positions and velocities of the target to a tracker.

16. The sensor of claim 1, wherein the sensor has a single direction for transmitting of electromagnetic waves towards the target and multiple directions for receiving electromagnetic waves reflected by the target.

17. A system including:
a sensor configured to transmit electromagnetic waves towards a target, and
a first redirecting device,
wherein the sensor is operable to detect, in response to the electromagnetic waves, first electromagnetic waves reflected by the target towards the sensor, and second electromagnetic waves received by the first redirecting device from the target and redirected by the first redirecting device towards the sensor, wherein the first and second electromagnetic waves are usable to determine data representative of at least one of a position and a velocity of the target.

18. The system of claim 17, including a second redirecting device, configured to redirect third electromagnetic waves received from the target towards the sensor or
more than two redirecting devices, each configured to redirect electromagnetic waves received from the target towards the sensor.

19. (canceled)

20. A method including:
transmitting, by a sensor, electromagnetic waves towards a target,
detecting first electromagnetic waves reflected by the target towards the sensor,
detecting second electromagnetic waves received by a first redirecting device from the target and redirected by the first redirecting device towards the sensor,
wherein the first and second electromagnetic waves are usable to determine data representative of at least one of a position and a velocity of the target.

21-35. (canceled)

36. A non-transitory computer readable medium comprising instructions that, when executed by a processor and memory circuitry (PMC), cause the PMC to perform operations comprising:
obtaining data representative of first electromagnetic waves reflected by a target towards a sensor in response to electromagnetic waves sent by the sensor,
obtaining data representative of second electromagnetic waves received by a first redirecting device from the target and redirected by the first redirecting device towards the sensor, and
using the first and second electromagnetic waves to determine data representative of at least one of a position and velocity of the target.

37. (canceled)

38. The sensor of claim 1, wherein a path of at least some of the electromagnetic waves transmitted by the sensor towards the target and reflected by the target into at least some of said second electromagnetic waves is such that, before the at least some of the second electromagnetic waves reach the first redirecting device, said path does not include the first redirecting device.
